(19) United States
(12) Patent Application Publication
(10) Pub. No.: US 2020/0065018 A1
(43) Pub. Date: Feb. 27, 2020

(54) MEMORY CONTROLLER AND OPERATING METHOD THEREOF

(71) Applicant: SK hynix Inc., Gyeonggi-do (KR)

(72) Inventor: Jiman HONG, Gyeonggi-do (KR)

(21) Appl. No.: 16/355,001

(22) Filed: Mar. 15, 2019

(30) Foreign Application Priority Data
Aug. 21, 2018 (KR) 10-2018-0097655

(51) Int. Cl. G06F 3/06; G06F 12/10

(52) U.S. Cl. CPC G06F 3/0644; G06F 3/0604; G06F 2212/657; G06F 12/10; G06F 3/0679

(57) ABSTRACT

A memory controller controls operations of a memory device. The memory controller includes a group read count storage and a data distribution controller. The group read count storage divides logical block addresses corresponding to data stored in the memory device into a plurality of logical block address groups and stores respective read count values of the data corresponding to the logical block addresses according to the logical block address groups. The data distribution controller controls the memory device to distribute and store data corresponding to a target logical block address group selected among the plurality of logical block address groups in a plurality of memory blocks based on the read count values stored according to the logical block address groups.

### CROSS-REFERENCE TO RELATED APPLICATION

The present application claims priority under 35 U.S.C. § 119(a) to Korean patent application number 10-2018-0097655, filed on Aug. 21, 2018, which is incorporated herein by reference in its entirety.

### BACKGROUND

### Field of Invention

Various embodiments of the present disclosure generally relate to an electronic device. Particularly, embodiments relate to a memory controller, a storage device and an operating method thereof.

### Description of Related Art

A memory device may have a two-dimensional structure in which strings are arranged in a horizontal direction to a semiconductor substrate, or a three-dimensional structure in which the strings are arranged in a vertical direction to the semiconductor substrate. A three-dimensional semiconductor device was devised to overcome the limited degree of integration in a two-dimensional semiconductor device, and may include a plurality of memory cells vertically stacked on a semiconductor substrate.

A memory controller may control operations of a memory device.

### SUMMARY

Various embodiments are directed to a memory controller extending an operating life of a semiconductor memory device.

Another embodiment of the invention provides a method of operating an improved memory controller extending an operating time of a semiconductor memory device.

According to an embodiment, a memory controller controlling operations of a memory device may include a group read count storage configured to divide logical block addresses corresponding to data stored in the memory device into a plurality of logical block address groups and store respective read count values of the data corresponding to the logical block addresses according to the logical block address groups, and a data distribution controller configured to control the memory device to distribute and store data corresponding to a target logical block address group selected among the plurality of logical block address groups in a plurality of memory blocks based on the read count values stored according to the logical block address groups.

According to an embodiment, a method of operating a memory device may include controlling the memory device to perform a read operation according to a read request received from a host, updating a read count value of a logical block address group including a logical block address corresponding to the read request, and controlling the memory device to perform a data distribution operation based on the updated read count value.

According to an embodiment, a memory system may include a memory device having memory blocks configured to store data and a controller configured to control operations of the memory device. The memory controller may be further configured to store logical block address groups, each containing a plurality of logical block addresses corresponding to data stored in the memory device, in association with respective read count values of the data corresponding to the logical block addresses of the respective logical block address groups, update the read count values upon receiving a read request or periodically, identify a target logical block address group, among the logical block address groups, having a read count value satisfying a specific condition, and move data corresponding to the target logical block address group stored in one or more source memory blocks, among the memory blocks, to one or more destination memory blocks, among the memory blocks, when the read count value of the target logical block address group satisfies the specific condition.

### BRIEF DESCRIPTION OF THE DRAWINGS

FIG. 1 is a block diagram illustrating a storage device including a memory controller according to an embodiment;

FIG. 2 is a block diagram illustrating a semiconductor memory device, such as that shown in FIG. 1;

FIG. 3 is a diagram illustrating an embodiment of a memory cell array shown in FIG. 2;

FIG. 4 is a circuit diagram illustrating an embodiment of a memory block BLKa, which is representative of any of the memory blocks BLK1 to BLKz shown in FIG. 3;

FIG. 5 is a circuit diagram illustrating an embodiment of a memory block BLKb, which is representative of any of the memory blocks BLK1 to BLKz shown in FIG. 3;

FIG. 6 is a circuit diagram illustrating an embodiment of a memory block BLKc, which is representative of any of the memory blocks BLK1 to BLKz in a memory cell array 110 shown in FIG. 2;

FIG. 7 is a block diagram illustrating a memory controller 200 according to an embodiment;

FIG. 8A is a block diagram illustrating an embodiment of a data distribution controller, such as that shown in FIG. 7;

FIG. 8B is a block diagram illustrating an embodiment of a data distribution controller, such as that shown in FIG. 7;

FIG. 9 is a table showing a read count value stored in a group read count storage, such as that illustrated in FIG. 8A or 8B;

FIG. 10 is a flowchart illustrating an operating method of a memory controller according to an embodiment;

FIG. 11 is a flowchart illustrating an embodiment of step S150 shown in FIG. 10;

FIGS. 12A to 12G are diagrams illustrating a method of operating a memory controller according to FIGS. 10 and 11;

FIG. 13 is a flowchart illustrating an embodiment of step S270 shown in FIG. 11;

FIG. 14 is a block diagram illustrating steps S310 and S330 of FIG. 13;

FIG. 15 is a flowchart illustrating an embodiment of step S150 shown in FIG. 10;

FIG. 16 is a block diagram illustrating an embodiment of a memory controller shown in FIG. 1;

FIG. 17 is a block diagram illustrating an application example of a storage device of FIG. 1; and

FIG. 18 is a block diagram illustrating a computing system including a storage device described with reference to FIG. 17.

### DETAILED DESCRIPTION

Various embodiments will now be described more fully with reference to the accompanying drawings. However, the present invention or aspects thereof may be embodied in different forms and thus should not be construed as limited to the embodiments set forth herein. Rather, these embodiments are provided so that this disclosure is thorough and complete and fully conveys the scope of the embodiments to those skilled in the art. Also, throughout the specification, reference to “an embodiment,” “another embodiment” or the like is not necessarily to only one embodiment, and different references to any such phrase are not necessarily to the same embodiment(s).

It will be understood that when an element is referred to as being “coupled” or “connected” to a certain element, it may be directly coupled or connected to the certain element, or it may be indirectly coupled or connected to the certain element with one or more intervening elements therebetween. Communication between two elements, whether directly or indirectly connected/coupled, may be wired or wireless, unless the context indicates otherwise. In the specification, when an element is referred to as “comprising” or “including” a component, it does not exclude one or more other components but may further include other component(s), unless the context indicates otherwise.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

As used herein, singular forms may include the plural forms as well and vice versa, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

In the drawings, like reference numerals refer to like elements throughout. In some embodiments, well-known processes, device structures, and technologies are not described in detail to avoid unnecessarily obscuring aspects and features of the present invention.

Hereinafter, the various embodiments of the present disclosure will be described in detail with reference to the attached drawings.

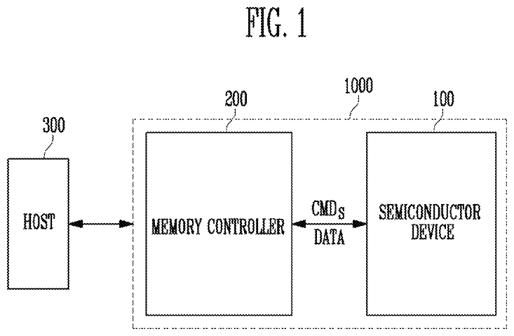

FIG. 1 is a block diagram illustrating a storage device 1000 including a semiconductor device 100 and a memory controller 200 according to an embodiment.

Referring to FIG. 1, the storage device 1000 may communicate with a host 300. The controller 200 may control the general operation of the semiconductor memory device 100. In addition, the memory controller 200 may control the operations of the semiconductor memory device 100 based on a command received by the host 300.

The memory controller 200 according to an embodiment of the disclosure may control the semiconductor memory device 100 to divide logical block addresses corresponding to data stored in the semiconductor memory device 100 into a plurality of logical block address groups and perform a data distribution operation according to a read count value corresponding to each of the logical block address groups. Therefore, a phenomenon in which a read operation is concentrated on a specific memory block may be avoided, so that an operating life of the semiconductor memory device 100 may be extended.

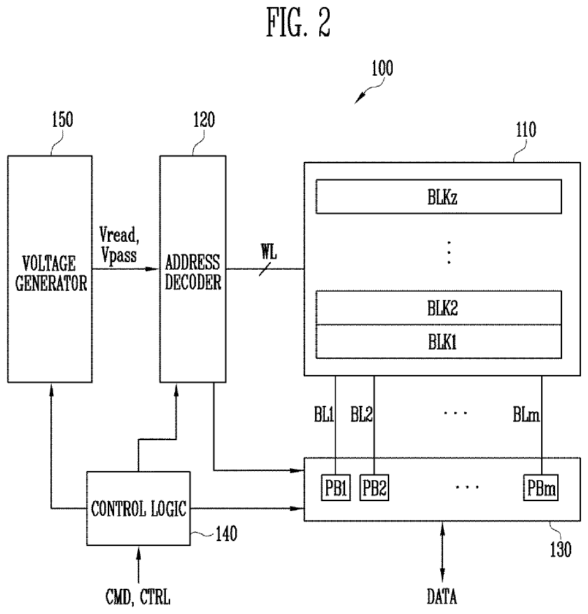

FIG. 2 is a block diagram illustrating the semiconductor memory device 100 shown in FIG. 1.

Referring to FIG. 2, the semiconductor memory device 100 may include a memory cell array 110, an address decoder 120, a read and write circuit 130, control logic 140, and a voltage generator 150.

The memory cell array 110 may include a plurality of memory blocks BLK1 to BLKz, which may be coupled to the address decoder 120 through word lines WL. The plurality of memory blocks BLK1 to BLKz may be coupled to the read and write circuit 130 through bit lines BL1 to BLm. Each of the plurality of memory blocks BLK1 to BLKz may include a plurality of memory cells. According to an embodiment, the plurality of memory cells may be non-volatile memory cells having a vertical channel structure. The memory cell array 110 may have a two-dimensional structure. According to an embodiment, the memory cell array 110 may have a three-dimensional structure. Each of the plurality of memory cells in the memory cell array 110 may store data of at least one bit. According to an embodiment, each of the plurality of memory cells may be a single-level cell (SLC) storing 1-bit data. According to another embodiment, each of the plurality of memory cells may be a multi-level cell (MLC) storing 2-bit data. According to another embodiment, each of the plurality of memory cells may be a triple-level cell (TLC) storing 3-bit data. According to another embodiment, each of the plurality of memory cells may be a quad-level cell (QLC) storing 4-bit data. According to an embodiment, each of the plurality of memory cells may store 5 or more bits of data.

The address decoder 120, the read and write circuit 130, the control logic 140 and the voltage generator 150 may operate as a peripheral circuit driving the memory cell array 110. The address decoder 120 may be coupled to the memory cell array 110 through the word lines WL. The address decoder 120 may be controlled by the control logic 140. The address decoder 120 may receive an address through an input/output buffer (not illustrated) in the semiconductor memory device 100.

The address decoder 120 may be configured to decode a block address of the received address. The address decoder 120 may select at least one memory block according to the decoded block address. In addition, during a read voltage applying operation of a read operation, the address decoder 120 may apply a read voltage Vread generated by the voltage generator 150 to a selected word line of a selected memory block and may apply a pass voltage Vpass to unselected word lines. In addition, during a program verify operation, a verify voltage generated by the voltage generator 150 may be applied to the selected word line of the selected memory block and the pass voltage Vpass may be applied to the unselected word lines.

The address decoder 120 may be configured to decode a column address of the received address. The address decoder 120 may transfer the decoded column address to the read and write circuit 130.

A read operation and a program operation of the semiconductor memory device 100 may be performed in units of pages. An address received at the request of a read operation and a program operation may include a block address, a row address, and a column address. The address decoder 120 may select one memory block and one word line in response to the block address and the row address. The column address may be decoded by the address decoder 120 and provided to the read and write circuit 130.

The address decoder 120 may include a block decoder, a row decoder, a column decoder, and an address buffer.

The read and write circuit 130 may include a plurality of page buffers PB1 to PBm. The read and write circuit 130 may operate as a read circuit during a read operation of the memory cell array 110 and a write circuit during a write operation thereof. The page buffers PB1 to PBm may be coupled to the memory cell array 110 through the bit lines BL1 to BLm, respectively. The page buffers PB1 to PBm may continuously supply a sensing current to bit lines coupled to memory cells in order to sense threshold voltages of the memory cells and may sense changes in amount of current caused by program states of the corresponding memory cells through a sensing node to latch sensing data during a read operation and a program verify operation. The read and write circuit 130 may operate in response to page buffer control signals output from the control logic 140.

The read and write circuit 130 may sense data of a memory cell, temporarily store the read data, and output data DATA to an input/output buffer (not illustrated) of the semiconductor memory device 100 during a read operation. According to an embodiment, the read and write circuit 130 may include a column selection circuit in addition to the page buffers PB1 to PBm (or page registers).

The control logic 140 may be coupled to the address decoder 120, the read and write circuit 130, and the voltage generator 150. The control logic 140 may receive a command CMD and a control signal CTRL through the input/output buffer (not illustrated) of the semiconductor memory device 100. The control logic 140 may be configured to control general operations of the semiconductor memory device 100 in response to the control signal CTRL. In addition, the control logic 140 may output a control signal to control sensing node precharge potential levels of the page buffers PB1 to PBm. The control logic 140 may control the read and write circuit 130 to perform a read operation of the memory cell array 110.

The voltage generator 150 may generate the read voltage Vread and the pass voltage Vpass in response to a control signal output from the control logic 140 during a read operation. The voltage generator 150 may include a plurality of pumping capacitors receiving an internal power voltage to generate a plurality of voltages having various voltage levels, and may generate a plurality of voltages by selectively activating the plurality of pumping capacitors in response to control of the control logic 140. As described above, the voltage generator 150 may include a charge pump, which may include the above-described pumping capacitors. The specific configuration of the charge pump included in the voltage generator 150 may be variously designed.

The address decoder 120, the read and write circuit 130, and the voltage generator 150 may function as a peripheral circuit configured to perform a read operation, a write operation, and an erase operation on the memory cell array 110. The control logic 140 may control the peripheral circuit to perform the read operation, the write operation, and the erase operation on the memory cell array 110.

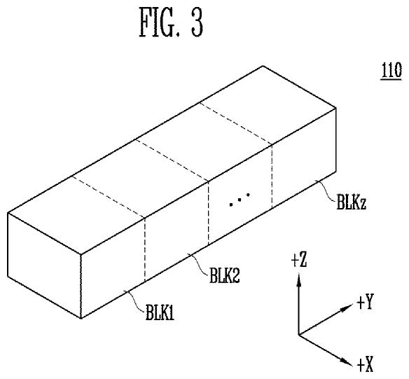

FIG. 3 shows an embodiment of the memory cell array 110 shown in FIG. 2.

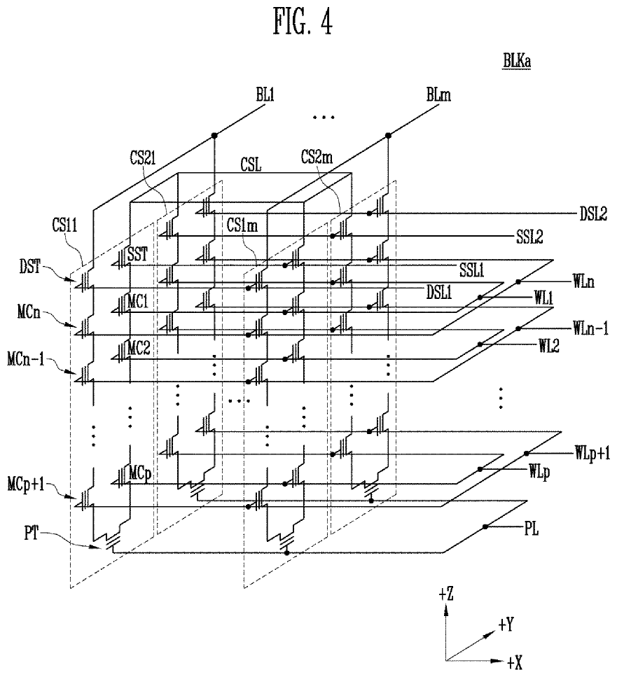

Referring to FIG. 3, the memory cell array 110 may include the plurality of memory blocks BLK1 to BLKz. Each of the memory blocks may have a three-dimensional structure. Each memory block may include a plurality of memory cells stacked over a substrate. The plurality of memory cells may be arranged in mutually orthogonal directions, e.g., +X direction, +Y direction and +Z direction, as shown in FIG. 3. The structure of each memory block will be described in detail below with reference to FIGS. 4 and 5.

FIG. 4 is a circuit diagram illustrating a representative one (BLKa) of the memory blocks BLK1 to BLKz shown in FIG. 3.

Referring to FIG. 4, the memory block BLKa may include a plurality of cell strings CS11 to CS1m and CS21 to CS2m. According to an embodiment, each of the cell strings CS11 to CS1m and CS21 to CS2m may be formed in a U shape. In the memory block BLKa, ‘m’ cell strings may be arranged in a row direction (i.e., +X direction). In FIG. 4, it is illustrated that two cell strings are arranged in a column direction (i.e., +Y direction). However, it is understood that three or more cell strings may be arranged in the column direction.

Each of the cell strings CS11 to CS1m and CS21 to CS2m may include at least one source select transistor SST, first to nth memory cells MC1 to MCn, a pipe transistor PT, and at least one drain select transistor DST.

Each of the select transistors SST and DST and each of the memory cells MC1 to MCn may have similar structures to each other. According to an embodiment, each of the select transistors SST and DST and the memory cells MC1 to MCn may include a channel layer, a tunneling insulating layer, a charge storage layer, and a blocking insulating layer. According to an embodiment, a pillar for providing a channel layer may be provided in each cell string. According to an embodiment, a pillar for providing at least one of the channel layer, the tunneling insulating layer, the charge storage layer, and the blocking insulating layer may be provided to each cell string.

The source select transistor SST of each cell string may be coupled between a common source line CSL and memory cells MC1 to MCp.

According to an embodiment, source select transistors of cell strings arranged in the same row may be coupled to a source select line extending in a row direction, and source select transistors of cell strings arranged in different rows may be coupled to different source select lines. In FIG. 4, source select transistors of the cell strings CS11 to CS1m in the first row may be coupled to a first source select line SSL1. Source select transistors of the cell strings CS21 to CS2m in the second row may be coupled to a second source select line SSL2.

According to another embodiment, the source select transistors of the cell strings CS11 to CS1m and CS21 to CS2m may be coupled in common to one source select line.

The first to nth memory cells MC1 to MCn of each cell string may be coupled between the source select transistor SST and the drain select transistor DST.

The first to nth memory cells MC1 to MCn may be divided into first to pth memory cells MC1 to MCp and (p+1)th to nth memory cells MCp+1 to MCn. The first to pth memory cells MC1 to MCp may be sequentially arranged in a −Z direction and may be coupled in series between the source select transistor SST and the pipe transistor PT. The (p+1)th to nth memory cells MCp+1 to MCn may be sequentially arranged in the +Z direction and may be coupled in series between the pipe transistor PT and the drain select transistor DST. The first to pth memory cells MC1 to MCp and the (p+1)th to nth memory cells MCp+1 to MCn may be coupled through the pipe transistor PT. Gates of the first to nth memory cells MC1 to MCn of each cell string may be coupled to first to nth word lines WL1 to WLn, respectively.

A gate of the pipe transistor PT of each cell string may be coupled to a pipe line PL.

The drain select transistor DST of each cell string may be coupled between the corresponding bit line and the memory cells MCp+1 to MCn. Cell strings arranged in the row direction may be coupled to a drain select line extending in the row direction. Drain select transistors of the cell strings CS11 to CS1m in the first row may be coupled to a first drain select line DSL1. Drain select transistors of the cell strings CS21 to CS2m in the second row may be coupled to a second drain select line DSL2.

Cell strings arranged in the column direction may be coupled to a bit line extending in the column direction. In FIG. 3, the cell strings CS11 and CS21 in the first column may be coupled to the first bit line BL1. The cell strings CS1m and CS2m in an mth column may be coupled to an mth bit line BLm.

Memory cells coupled to the same word line arranged in cell strings arranged in the row direction may form a single page. For example, memory cells coupled to the first word line WL1 in the cell strings CS11 to CS1m in the first row may constitute a single page. Memory cells coupled to the first word line WL1 in the cell strings CS21 to CS2m in the second row may constitute another page. When one of the drain select lines DSL1 and DSL2 is selected, cell strings arranged in one row direction may be selected. When one of the first to nth word lines WL1 to WLn is selected, one page may be selected from the selected cell strings.

In another embodiment, even bit lines and odd bit lines may be provided instead of the first to mth bit lines BL1 to BLm. In addition, even cell strings of the cell strings CS11 to CS1m or CS21 to CS2m arranged in the row direction may be coupled to even bit lines, respectively, and odd cell strings of the cell strings CS11 to CS1m or CS21 to CS2m arranged in the row direction may be coupled to odd bit lines, respectively.

According to an embodiment, at least one of the first to nth memory cells MC1 to MCn may serve as a dummy memory cell. For example, one or more dummy memory cells may be provided to reduce an electric field between the source select transistor SST and the memory cells MC1 to MCp. Alternatively, one or more dummy memory cells may be provided to reduce an electric field between the drain select transistor DST and the memory cells MCp+1 to MCn. When more dummy memory cells are provided, the operational reliability of the memory block BLKa may increase, whereas the size of the memory block BLKa may increase. On the other hand, when the number of dummy memory cells decreases, the size of the memory block BLKa may be reduced, and the operational reliability of the memory block BLKa may be reduced.

In order to efficiently control the dummy memory cell(s), each may have a required threshold voltage. Before or after an erase operation on the memory block BLKa, program operations may be performed on a portion or entirety of the dummy memory cells. When an erase operation is performed after a program operation is performed, the dummy memory cells may have required threshold voltages by controlling a voltage applied to dummy word lines coupled to the dummy memory cells.

FIG. 5 is a circuit diagram illustrating another embodiment of a representative memory block BLKb, among the memory blocks BLK1 to BLKz shown in FIG. 3.

Referring to FIG. 5, the memory block BLKb may include a plurality of cell strings CS11′ to CS1m′ and CS21′ to CS2m′. Each of the plurality of cell strings CS11′ to CS1m′ and CS21′ to CS2m′ may extend in the +Z direction. Each of the plurality of cell strings CS11′ to CS1m′ and CS21′ to CS2m′ may include at least one source select transistor SST, the first to nth memory cells MC1 to MCn, and at least one drain select transistor DST, which are stacked on a substrate (not shown) under a memory block BLK1′.

The source select transistor SST of each cell string may be coupled between the common source line CSL and the first to nth memory cells MC1 to MCn. Source select transistors of cell strings arranged in the same row may be coupled to the same source select line. Source select transistors of the cell strings CS11′ to CS1m′ arranged in the first row may be coupled to the first source select line SSL1. Source select transistors of the cell strings CS21′ to CS2m′ arranged in the second row may be coupled to the second source select line SSL2. According to another embodiment, the source select transistors of the cell strings CS11′ to CS1m′ and CS21′ to CS2m′ may be commonly coupled to a single source select line.

The first to nth memory cells MC1 to MCn of each cell string may be coupled in series between the source select transistor SST and the drain select transistor DST. Gates of the first to nth memory cells MC1 to MCn may be coupled to the first to nth word lines WL1 to WLn, respectively.

The drain select transistor DST of each cell string may be coupled between the corresponding bit line and the memory cells MC1 to MCn. Drain select transistors of cell strings arranged in the row direction may be coupled to a drain select line extending in the row direction. Drain select transistors of the cell strings CS11′ to CS1m′ in the first row may be coupled to the first drain select line DSL1. Drain select transistors of the cell strings CS21′ to CS2m′ in the second row may be coupled to the second drain select line DSL2.

As a result, the memory block BLKb shown in FIG. 5 may have a similar or equivalent circuit to the memory block BLKa shown in FIG. 4. For instance, the pipe transistor PT may be removed from each cell string of the memory block BLKb of FIG. 5.

In another embodiment, even bit lines and odd bit lines may be provided instead of the first to mth bit lines BL1 to BLm. Even cell strings of the cell strings CS11′ to CS1m′ or CS21′ to CS2m′ arranged in the row direction may be coupled to the even bit lines, respectively, and odd cell strings of the cell strings CS11′ to CS1m′ or CS21′ to CS2m′ arranged in the row direction may be coupled to the odd bit lines, respectively.

According to an embodiment, at least one of the first to nth memory cells MC1 to MCn may serve as a dummy memory cell. For example, one or more dummy memory cells may be provided to reduce an electric field between the source select transistor SST and the first to nth memory cells MC1 to MCn. Alternatively, one or more dummy memory cells may be provided to reduce an electric field between the drain select transistor DST and the memory cells MC1 to MCn. When more dummy memory cells are provided, the operational reliability of the memory block BLKb may increase, whereas the size of the memory block BLKb may increase. When fewer memory cells are provided, the size of the memory block BLKb may be reduced and the operational reliability of the memory block BLKb may be degraded.

In order to efficiently control the dummy memory cell(s), each may have a required threshold voltage. Before or after an erase operation on the memory block BLKb, program operations may be performed on a portion or entirety of the dummy memory cells. When an erase operation is performed after a program operation is performed, the dummy memory cells may have required threshold voltages by controlling a voltage applied to dummy word lines coupled to the dummy memory cells.

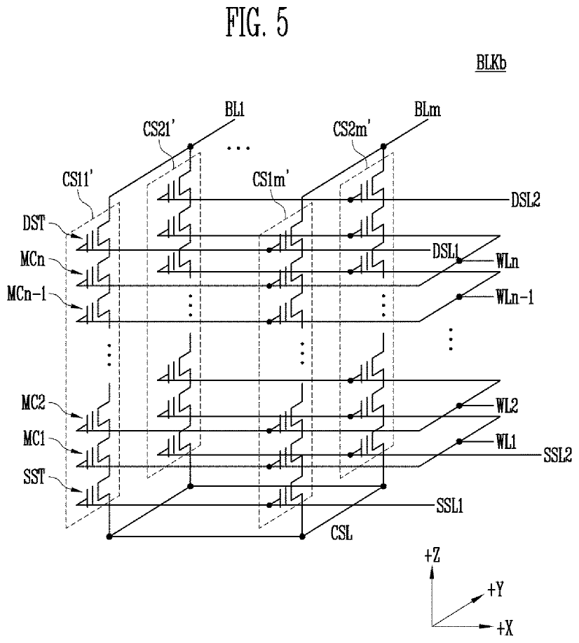

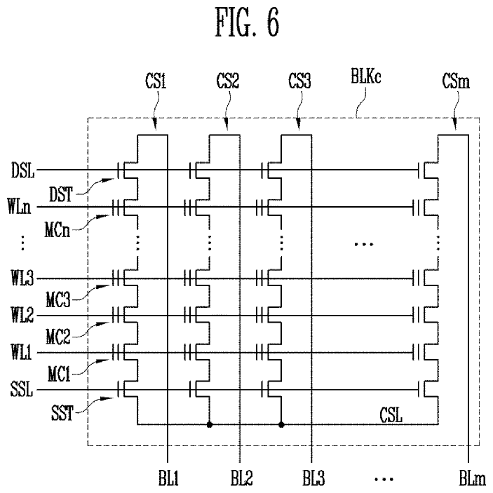

FIG. 6 is a circuit diagram illustrating an embodiment of a memory block BLKc, which is representative of any of the memory blocks BLK1 to BLKz in the memory cell array 110 shown in FIG. 2.

Referring to FIG. 6, the memory block BLKc may include a plurality of cell strings CS1 to CSm. The plurality of cell strings CS1 to CSm may be coupled to the plurality of bit lines BL1 to BLm, respectively. Each of the cell strings CS1 to CSm may include at least one source select transistor SST, the first to nth memory cells MC1 to MCn, and at least one drain select transistor DST.

Each of the select transistors SST and DST and each of the memory cells MC1 to MCn may have similar structures to each other. According to an embodiment, each of the select transistors SST and DST and the memory cells MC1 to MCn may include a channel layer, a tunneling insulating layer, a charge storage layer, and a blocking insulating layer. According to an embodiment, a pillar for providing a channel layer may be provided in each cell string. According to an embodiment, a pillar for providing at least one of the channel layer, the tunneling insulating layer, the charge storage layer, and the blocking insulating layer may be provided to each cell string.

The source select transistor SST of each cell string may be coupled between the common source line CSL and the first to nth memory cells MC1 to MCn.

The first to nth memory cells MC1 to MCn of each cell string may be coupled between the source select transistor SST and the drain select transistor DST.

The drain select transistor DST of each cell string may be coupled between a corresponding bit line and the memory cells MC1 to MCn.

Memory cells coupled to the same word line may form a single page. When the drain select line DSL is selected, the cell strings CS1 to CSm may be selected. When one of the word lines WL1 to WLn is selected, one page may be selected from selected cell strings.

In another embodiment, even bit lines and odd bit lines may be provided instead of first to mth bit lines BL1 to BLm. Even cell strings of the cell strings CS1 to CSm may be coupled to the even bit lines, respectively, and odd cell strings thereof may be coupled to the odd bit lines, respectively.

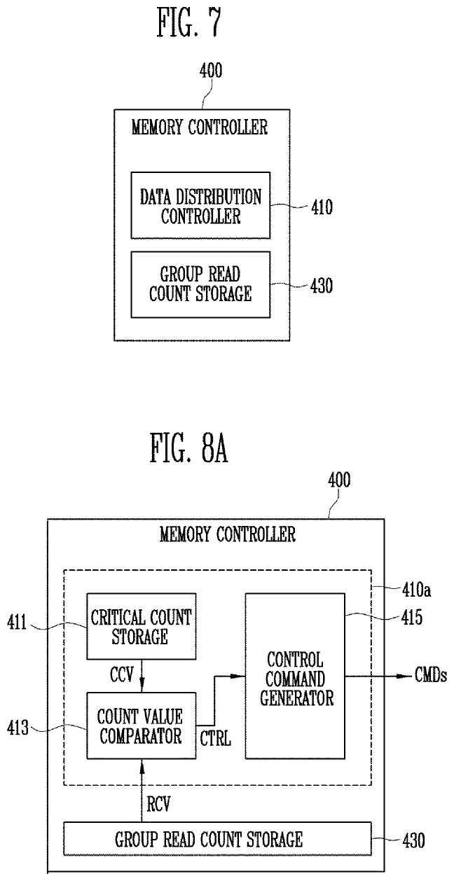

FIG. 7 is a block diagram illustrating a memory controller 400 according to an embodiment.

Referring to FIG. 7, the memory controller 400, which may operate in connection with the semiconductor device 100 of FIG. 1, may include a data distribution controller 410 and a group read count storage 430. The group read count storage 430 may divide logical block addresses LBAs corresponding to data stored in the semiconductor memory device 100 into a plurality of logical block address groups and store read count values of the data corresponding to the logical block addresses LBAs according to the respective logical block address groups.

The data distribution controller 410 may control the semiconductor memory device 100 to distribute and store data corresponding to a selected target logical block address group, among the plurality of logical block address groups, in a plurality of memory blocks based on the read count values stored in the group read count storage 430 according to the respective logical block address groups.

When data with a high read frequency is concentrated on and stored in a particular memory block, a read operation may be performed generally on that memory block. As a result, a read reclaim operation may be frequently performed on that memory block.

According to an embodiment, the memory controller 200 may distribute and store data corresponding to the logical block address group with the high read frequency based on the read count values corresponding to the plurality of logical block address groups. Therefore, the read operation focused on a specific memory block may be distributed across a plurality of memory blocks. Accordingly, the operating life of the semiconductor memory device 100 and the storage device 1000 including the same may be extended.

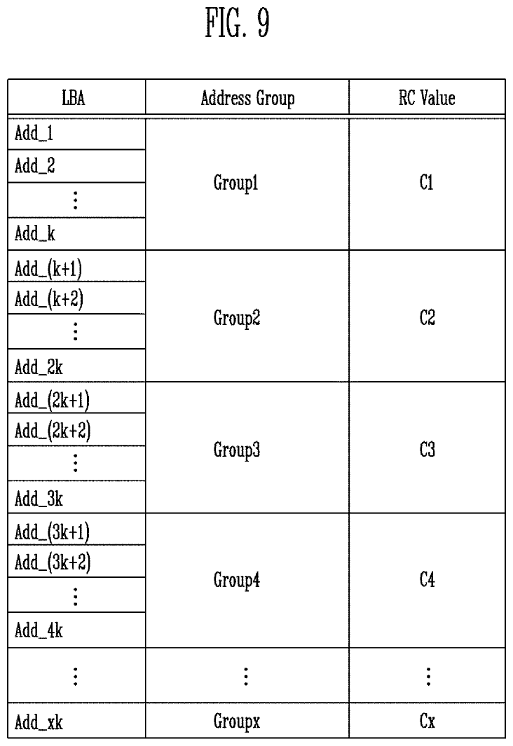

The logical block address groups and the read count values corresponding thereto will be described below in detail with reference to FIG. 9.

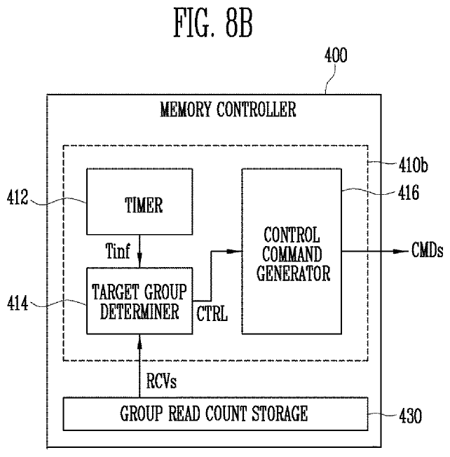

FIG. 8A is a block diagram illustrating an embodiment of the data distribution controller 410 shown in FIG. 7. In this embodiment, the data distribution controller is identified by 410a.

Referring to FIG. 8A, the data distribution controller 410a may include a critical count storage 411, a count value comparator 413, and a control command generator 415.

The critical count storage 411 may store a critical count value CCV. The critical count value CCV may be provided to the count value comparator 413.

In addition to receiving the critical count value CCV, the count value comparator 413 may receive a read count value RCV of a target logical block address group from the group read count storage 430. The count value comparator 413 may compare the critical count value CCV with the read count value RCV and determine whether or not to perform a distribution operation on data corresponding to the target logical block address group.

When the count value comparator 413 determines to perform the distribution operation on the data corresponding to the target logical block address group, the count value comparator 413 may transfer a control signal CTRL to the control command generator 415. Based on the control signal CTRL, the control command generator 415 may generate commands CMDs for controlling the semiconductor memory device 100 to distribute the data corresponding to the target logical block address group across a plurality of destination memory blocks. For example, the commands CMDs may include a read command for reading the data corresponding to the target logical block address group and a program command for programming the plurality of destination memory blocks with the data read by the read command.

In an embodiment of FIG. 8A, whenever the group read count storage 430 receives a read request from the host 300, the group read count storage 430 may determine a logical block address group including a logical block address corresponding to the read request as a target logical block address group. In addition, the group read count storage 430 may provide the read count value RCV corresponding to the determined target logical block address group to the count value comparator 413.

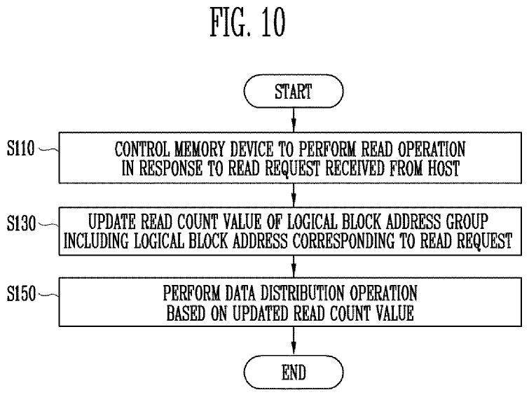

The method of operating the memory controller 400 shown in FIG. 8A will be described below in more detail with reference to FIGS. 10 to 14.

FIG. 8B is a block diagram illustrating another embodiment of the data distribution controller 410 shown in FIG. 7. In this embodiment, the data distribution controller is identified by 410b.

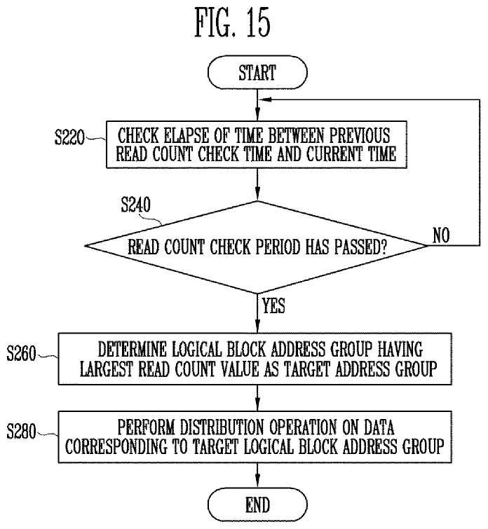

Referring to FIG. 8B, the data distribution controller 410b may include a timer 412, a target group determiner 414, and a control command generator 416. The timer 412 may generate and transfer time information Tinf to the target group determiner 414. The target group determiner 414 may determine whether a read count check period has elapsed based on time information Tinf. In addition, when the read count check period has elapsed, the target group determiner 414 may determine a target logical block address group, among the plurality of logical block address groups, based on read count values RCVs received from the group read count storage 430. The target group determiner 414 may generate the control signal CTRL for distributing data corresponding to the determined target logical block address group and may transfer the control signal CTRL to the control command generator 416. Based on the control signal CTRL, the control command generator 416 may generate the commands CMDs for controlling the semiconductor memory device 100 to distribute the data corresponding to the target logical block address group across a plurality of destination memory blocks. For example, the commands CMDs may include a read command for reading the data corresponding to the target logical block address group and a program command for programming the plurality of destination memory blocks with the data read by the read command. The operating method of the memory controller 400 shown in FIG. 8B will be described below in more detail with reference to FIG. 15.

In an embodiment of FIG. 8A, the logical block address group including the logical block address corresponding to the read request from the host 300 may be determined as the target logical block address group. On the other hand, in an embodiment of FIG. 8B, a logical block address group having the largest read count value among the plurality of logical block address groups may be determined as the target logical block address group.

According to an embodiment of FIG. 8A, whenever a read request is received from the host, the data distribution controller 410a may compare a read count value of a logical block address group corresponding to the received read request with a critical count value. When the read count value is greater than or equal to the critical count value, the data of the logical block address group corresponding to the received read request may be distributed and stored in the plurality of memory blocks.

According to an embodiment of FIG. 8B, the data distribution controller 410b may check read count values of the entirety of the logical block address groups every set or predetermined read count period, and may distribute and store data of a logical block address group having the highest read count value in a plurality of memory blocks.

According to an embodiments of FIGS. 8A and 8B, data of a logical block address group having a high read count value may be distributed and stored in a plurality of memory blocks. Therefore, a read operation focused on some memory blocks may be distributed across a plurality of memory blocks. Accordingly, the operating life of the semiconductor memory device 100 and the storage device 1000 including the same may be extended.

FIG. 9 is a table showing read count values stored in the group read count storage 430. The read count (RC) values are stored in correspondence with their respective logical block address groups, as shown in FIG. 9.

Referring to FIG. 9, logical block addresses LBAs corresponding to a unit of a read operation may be listed. The logical block addresses may range from Add_1 to Add_xk. In FIG. 9, the logical block addresses Add1 to Add_xk may be in ascending order.

First logical block addresses Add_1 to Add_k, among the logical block addresses Add1 to Add_xk, may be included in a first logical block address group Group1. Second logical block addresses Add_(k+1) to Add_2k may be included in a second logical block address group Group2. In this way, the logical block addresses Add1 to Add_xk may be grouped into first, second, . . . , xth logical block address groups Group1, Group2, . . . , and Groupx.

With respect to each of the logical block address groups Group1, Group2, . . . , and Groupx, the read count (RC) values may be stored in the group read count storage 430. In FIG. 9, a read count value C1 may correspond to the first logical block address group Group1. This may mean that a read operation is performed C1 times on data corresponding to logical block addresses in the first logical block address group Group1.

A read count value C2 may correspond to the second logical block address group Group2. This may mean that a read operation is performed C2 times on data corresponding to logical block addresses in the second logical block address group Group2.

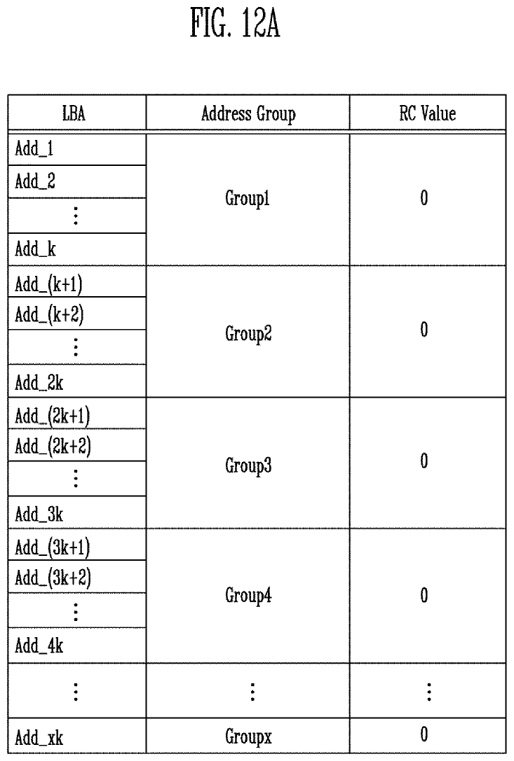

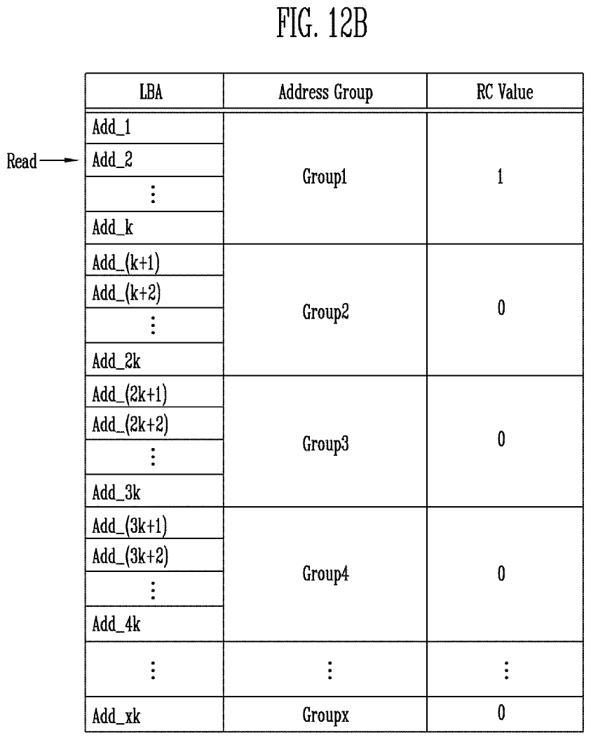

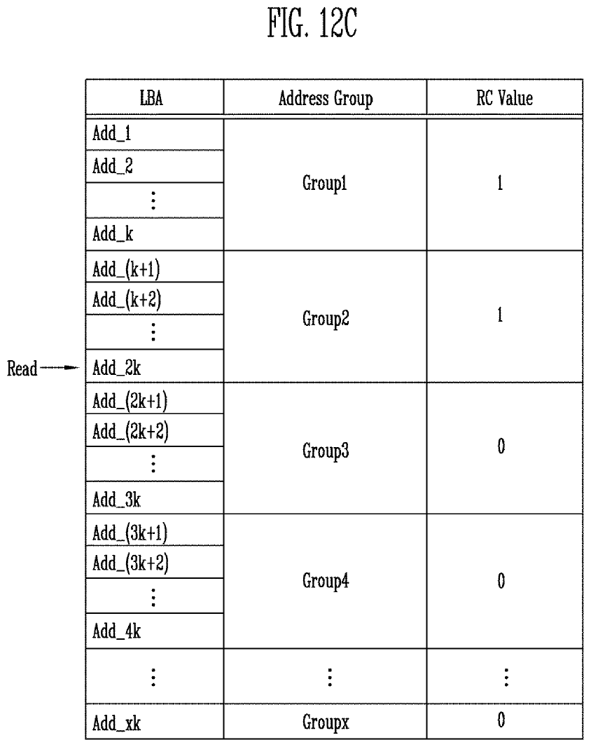

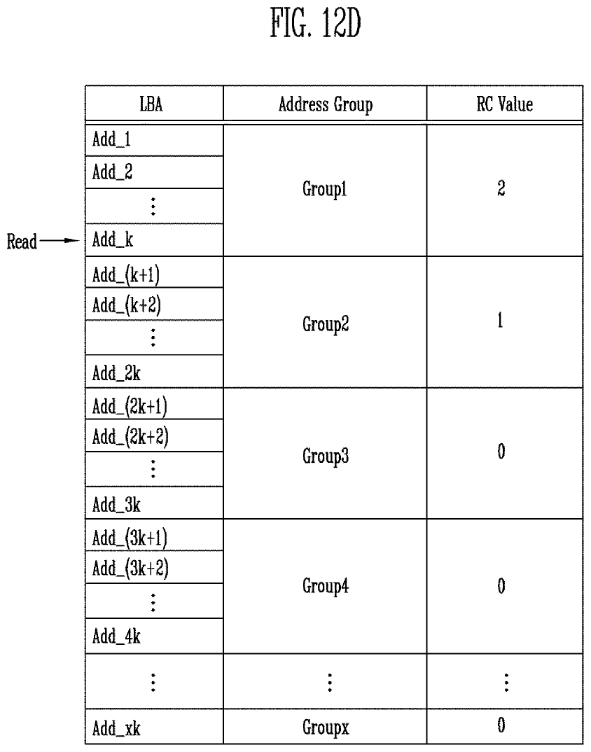

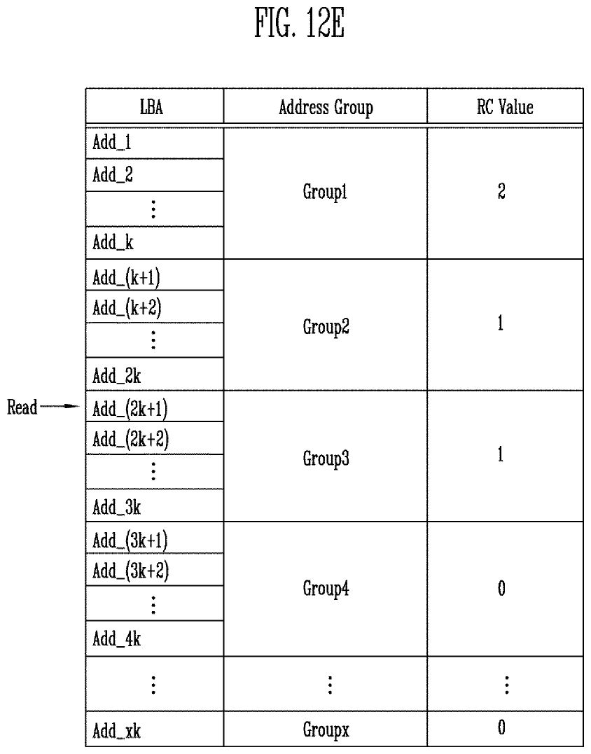

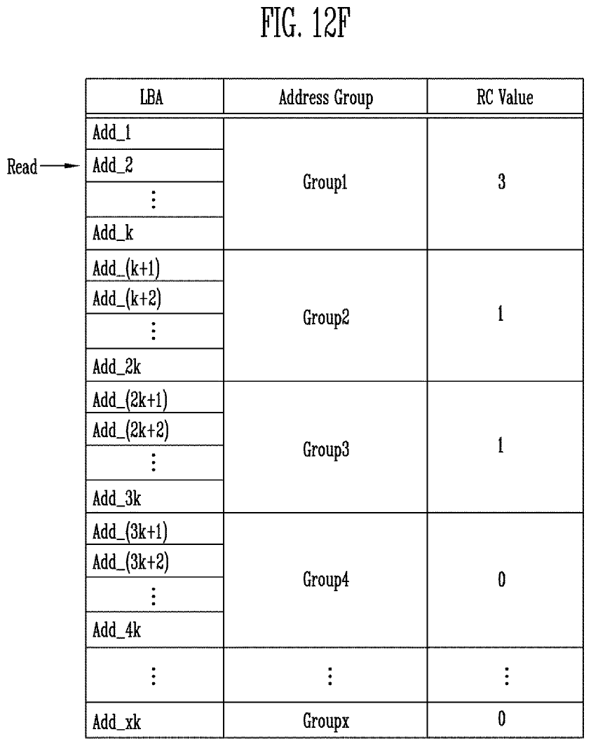

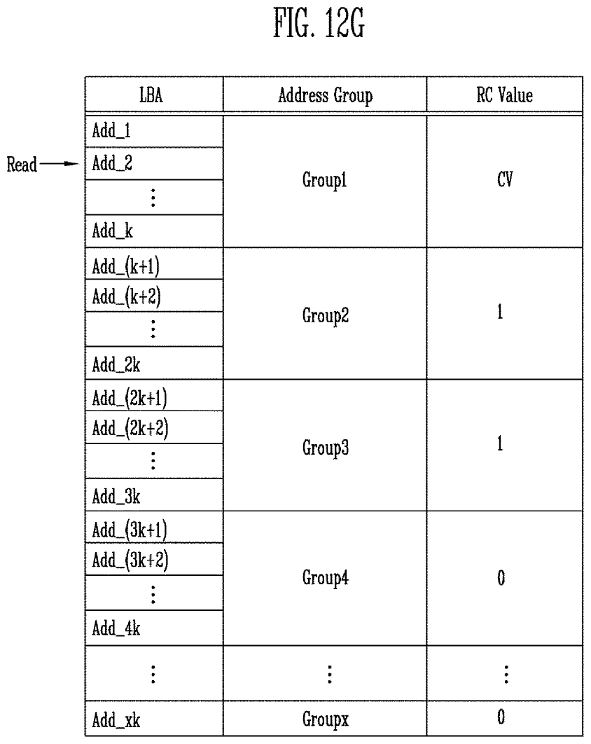

More generally, each of the logical block address groups Group1, Group2, . . . , and Groupx has an associated read count (RC) value that may be stored in the group read count storage 430. Whenever a read operation corresponding to a read request from the host 300 is performed, a read count (RC) count of a logical block address group corresponding to the read request may be updated. A method of updating the read count (RC) value of the logical block address group will be described below in detail with reference to FIGS. 12A to 12G.

FIG. 10 is a flowchart illustrating an operating method of the memory controller 200 according to an embodiment.

Referring to FIG. 10, a method of operating a memory controller according to an embodiment may include controlling the semiconductor memory device 100 to perform a read operation in response to a read request from the host 300 (S110), updating a read count value of a logical block address group including a logical block address corresponding to the read request (S130), and performing a data distribution operation based on the updated read count value (S150).

At step S110, the read request may be received from the host 300, and the semiconductor memory device 100 may be controlled to perform a read operation corresponding to the read request. At step S110, the memory controller 200 may receive the read request from the host 300 and convert a logical block address corresponding to the read request into a physical block address. In addition, at step S110, the memory controller 200 may generate a read command corresponding to the physical block address and transfer the read command to the semiconductor memory device 100. The semiconductor memory device 100 may perform a read operation in response to the received read command. The data which is read as a result of the read operation may be transferred to the memory controller 200 and finally to the host 300.

At step S130, a read count value including the logical block address corresponding to the read request may be updated. The specific method of carrying out step S130 will be described below with reference to FIGS. 12A to 12G.

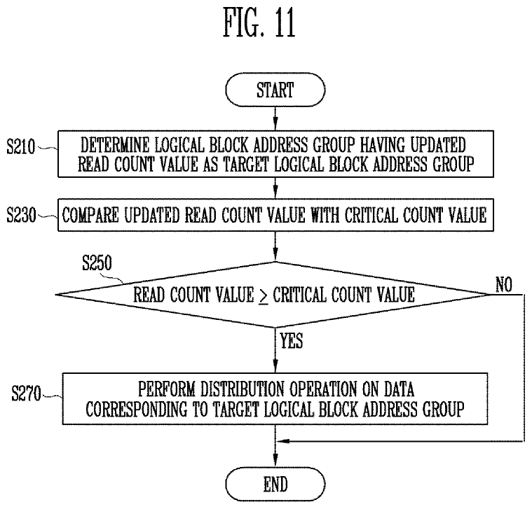

At step S150, a data distribution operation may be performed based on the updated read count value. An embodiment of step S150 will be described below with reference to FIG. 11.

FIG. 11 is a flowchart illustrating an embodiment of step S150 shown in FIG. 10.

Referring to FIG. 11, step S150 may include determining the logical block address group having the updated read count value as a target logical block address group (S210), comparing the updated read count value RCV with the critical count value CCV (S230), determining whether the read count value RCV is greater than or equal to the critical count value CCV (S250), and performing a distribution operation on data corresponding to the target logical block address group based on the result of determination (S270).

At step S130 of FIG. 10, a read count value of a logical block address group including the logical block address corresponding to the read request received from the host 300 may be updated, and at step S210 of FIG. 11, the logical block address group having the updated read count value may be determined as the target logical block address group. That is, as described above with reference to FIG. 8A, the logical block address group including the logical block address corresponding to the read request received from the host 300 may be determined as the target logical block address group.

At step S230, in the same manner as described above with reference to FIG. 8A, the count value comparator 413 may compare the updated read count value RCV with the critical count value CCV.

At step S250, it may be determined whether or not the read count value RCV is greater than or equal to the critical count value CCV. When the read count value RCV is greater than or equal to the critical count value CCV (that is, “YES” at step S250), the process flow may proceed to step S270 and a distribution operation on data corresponding to the target logical block address group may be performed. On the other hand, when the read count value RCV is less than the critical count value CCV, the distribution operation of the data may not be performed. When the read count value RCV is less than the critical count value CCV (that is, “NO” at step S250), the process may end.

FIGS. 12A to 12G are diagrams illustrating a method of operating the memory controller 200 according to FIGS. 10 and 11.

Referring to FIG. 12A, read count values corresponding to all logical block address groups are illustrated as being initialized to zero (0). Thus, when the semiconductor memory device 100 starts to operate, each of the read count values corresponding to all logical block address groups may have a value of zero (0) as shown in FIG. 12A.

Referring to FIG. 12B, a read count update operation, when a read request corresponding to a logical block address Add_2 is received from the host 300, is illustrated. Since the logical block address Add_2 is included in the first logical block address group Group1, a read count (RC) value of the first logical block address group Group1 may be increased by 1. The first logical block address group Group1 may be a target logical block address group. However, since the read count (RC) value of the target logical block address group is less than the critical count value, a data distribution operation may not be performed.

Referring to FIG. 12C, a read count update operation, when a read request corresponding to a logical block address Add_2k is received from the host 300, is illustrated. Since the logical block address Add_2k is included in the second logical block address group Group2, a read count (RC) value of the second logical block address group Group2 may be increased by 1. The second logical block address group Group2 may be a target logical block address group. However, since the read count (RC) value of the target logical block address group is less than the critical count value, a data distribution operation may not be performed.

Referring to FIG. 12D, a read count update operation, when a read request corresponding to the logical block address Add_k is received from the host 300, is illustrated. Since the logical block address Add_k is included in the first logical block address group Group1, the read count (RC) value of the first logical block address group Group1 may be increased by 1. The first logical block address group Group1 may be a target logical block address group. However, since the read count (RC) value of the target logical block address group is less than the critical count value, a data distribution operation may not be performed.

Referring to FIG. 12E, a read count update operation, when a read request corresponding to a logical block address ADD_(2k+1) is received from the host 300, is illustrated. Since the logical block address ADD_(2k+1) is included in a third logical block address group Group3, a read count (RC) value of the third logical block address group Group3 may be increased by 1. The third logical block address Group3 may be a target logical block address group. However, since the read count (RC) value of the target logical block address group is less than the critical count value, a data distribution operation may not be performed.

Referring to FIG. 12F, a read count update operation, when a read request corresponding to the logical block address Add_2 is received from the host 300, is illustrated. Since the logical block address Add_2 is included in the first logical block address group Group1, the read count (RC) value of the first logical block address group Group1 may be increased by 1. The first logical block address group Group1 may be a target logical block address group. However, since the read count (RC) value of the target logical block address group is less than the critical count value, a data distribution operation may not be performed.

Referring to FIG. 12G, a read count update operation, when a read request corresponding to the logical block address Add_2 is received again from the host 300, is illustrated. Since the logical block address Add_2 is included in the first logical block address group Group1, the read count (RC) value of the first logical block address group Group1 may be increased by 1. The first logical block address group Group1 may be a target logical block address group. In addition, the read count (RC) value of the target logical block address group may reach the critical count value CV. In the example of FIG. 12G, the critical count value CV may be 4. Since the read count (RC) value of the target logical block address group reaches the critical count value CV, a distribution operation on data corresponding to the first logical block address group which is the target logical block address group may be performed. In other words, data corresponding to the first logical block address Add_1 to Add_k may be distributed and stored in the plurality of memory blocks.

After the data distribution operation is performed, the read count value of the first logical block address group Group1 which is the target logical block address group may be initialized to a value of zero (0) since data corresponding to the first logical block address group Group1 may be transferred to other memory blocks.

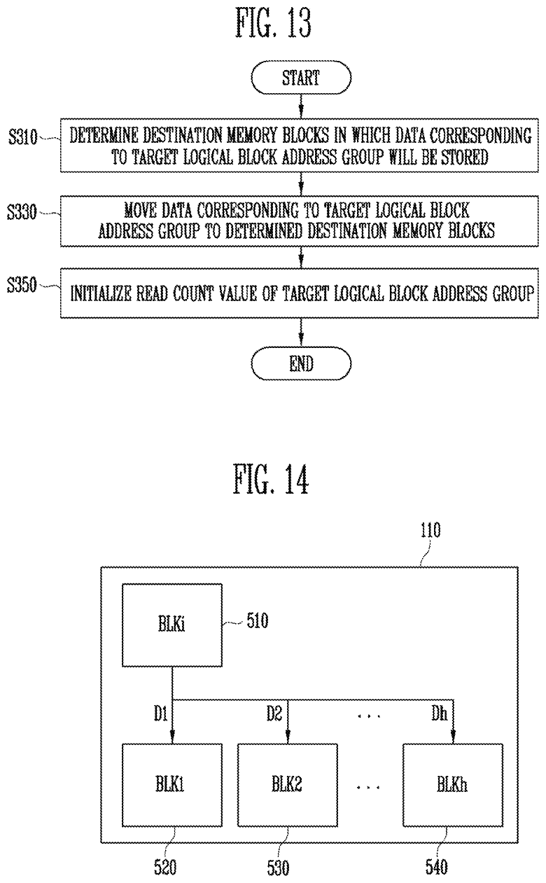

FIG. 13 is a flowchart illustrating an embodiment of step S270 shown in FIG. 11. FIG. 14 is a block diagram illustrating steps S310 and S330 of FIG. 13.

Referring to FIG. 13, step S270 of FIG. 11 may include determining destination memory blocks in which data corresponding to the target logical block address group will be stored (S310), moving data corresponding to the target logical block address group to the destination memory blocks (S330), and initializing a read count value of the target logical block address group (S350).

As illustrated in FIG. 14, data corresponding to the target logical block address group may be stored in an ith block BLKi of the memory cell array 100 in the semiconductor memory device 100. At step S310, destination memory blocks BLK1 to BLKh (520 to 540) may be determined.

The determined destination memory blocks BLK1 to BLKh (520 to 540) may be selected from open blocks which are currently being used, among the memory blocks in the memory cell array 110. An open block may refer to a memory block that stores data and has a free space in which additional data is stored. In another embodiment, the determined destination memory blocks BLK1 to BLKh (520 to 540) may be selected from free blocks of the memory blocks in the memory cell array 110. A free block may refer to a memory block in which data is not currently stored. In another embodiment, the destination memory blocks BLK1 to BLKh (520 to 540) may be determined to include both open and free blocks.

At step S330, data D1, D1, . . . , Dh in the ith block BLKi may be distributed and stored in the destination memory blocks BLK1 to BLKh (520 to 540). At step S350, the read count value of the target logical block address group may be initialized to zero (0).

An embodiment in which a data distribution operation when data corresponding to the target logical block address group is stored in one memory block BLKi (510) is illustrated in FIG. 14. However, the data corresponding to the target logical block address group may be stored in two or more memory blocks. The data stored in the two or more memory blocks may be distributed and stored in selected destination memory blocks as explained above.

After the data distribution operation is performed, the read count value of the target logical block address group may be initialized (S350). Therefore, the read count (RC) value of the target logical block address group Group1 may be initialized to zero (0).

FIG. 15 is a flowchart illustrating another embodiment of step S150 of FIG. 10.

Referring to FIG. 15, step S150 may include checking an elapse of time between the previous read count check time and the current time (S220), determining whether a read count check period has elapsed (S240), determining a logical block address group having the largest read count value as a target address block group (S260), and performing a distribution operation on data corresponding to the target logical block address group (S280). Therefore, data corresponding to a logical block address group having the largest read count value may be periodically distributed and stored in a plurality of memory blocks. The steps of FIG. 15 may be performed by the data distribution controller 410b shown in FIG. 8B. Thus, the following description is with reference to FIGS. 15 and 8B.

First, at step S220, an elapse of time between the previous read count check time and the current time may be checked. A data distribution operation may be performed by selecting a target logical block address group every set or predetermined period. The timer 412 of the data distribution controller 410b may repetitively generate and transfer the time information Tinf to the target group determiner 414. The target group determiner 414 may check the elapse of time between the previous read count check time and the current time based on the received time information Tinf. A distribution operation on data corresponding to the target logical block address group based on the read count value may be performed at the previous read count check time. The target group determiner 414 may check whether the read count check period has elapsed from the previous count check time based on the time information Tinf. As a result of the determination of step S240, when the read count check period has not passed yet, the target group determiner 414 may continue on checking the elapse of time (S220).

As a result of the determination of step S240, when the read count check period has elapsed, the target group determiner 414 may determine a logical block address group having the largest read count value, among a plurality of logical block address groups Group1 to Groupx, as the target logical block address group (S260). The group read count storage 430 may provide the read count values RCVs corresponding to the respective logical block address groups to the target group determiner 414. The target group determiner 414 may determine a logical block address group corresponding to the largest read count value, among the provided the read count values RCVs, as the target logical block address group.

At step S280, a distribution operation on data corresponding to the target logical block address group may be performed. The target group determiner 414 may generate the control signal CTRL for performing a data distribution operation on a selected target logical block address group and transfer the control signal CTRL to the control command generator 416. Based on the control signal CTRL, the control command generator 416 may generate the commands CMDs for controlling the semiconductor memory device 100 to distribute the data corresponding to the target logical block address group across a plurality of destination memory blocks. For example, the commands CMDs may include a read command for reading the data corresponding to the target logical block address group and a program command for programming the plurality of destination memory blocks with the data read by the read command.

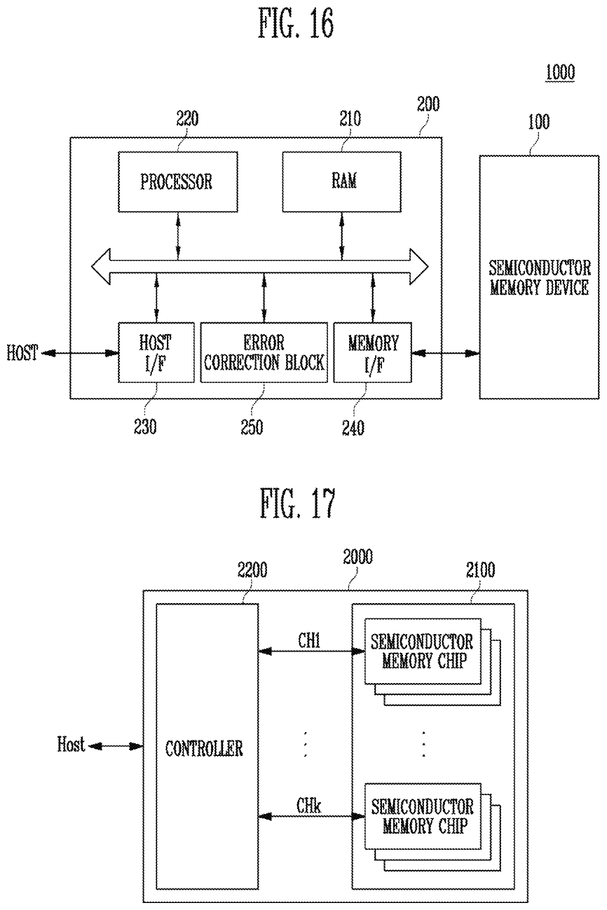

FIG. 16 is a block diagram illustrating an embodiment of the memory controller 200 shown in FIG. 1.

Referring to FIG. 16, the memory controller 200 may be coupled between the semiconductor memory device 100 and a host. The semiconductor memory device 100 may be the semiconductor memory device described with reference to FIG. 2. The memory controller 200 may correspond to the memory controller 200 of FIG. 1. Accordingly, description of common elements is omitted here.

The memory controller 200 may be configured to access the semiconductor memory device 100 at the request of the host. For example, the memory controller 200 may control a read operation, a program operation, an erase operation, and/or a background operation of the semiconductor memory device 100. The memory controller 200 may be configured to provide an interface between the semiconductor memory device 100 and the host. The memory controller 200 may be configured to drive firmware for controlling the semiconductor memory device 100.

The memory controller 200 may include a random access memory (RAM) 210, a processor 220, a host interface 230, a memory interface 240, and an error correction block 250. The RAM 210 may serve as at least one of an operation memory of the processor 220, a cache memory between the semiconductor memory device 100 and the host, and a buffer memory between the semiconductor memory device 100 and the host. In addition, the RAM 210 may serve as a command queue for temporarily storing commands to be transferred to the semiconductor memory device 100.

The processor 220 may control general operations of the controller 200.

The host interface 230 may include a protocol for exchanging data between the host and the memory controller 200. According to an embodiment, the memory controller 200 may communicate with the host using at least one of a variety of interface protocols, such as a universal serial bus (USB) protocol, a multimedia card (MMC) protocol, a peripheral component interconnection (PCI) protocol, a PCI-Express (PCI-E) protocol, an advanced technology attachment (ATA) protocol, a Serial-ATA protocol, a Parallel-ATA protocol, a small computer small interface (SCSI) protocol, an enhanced small disk interface (ESDI) protocol, an integrated drive electronics (IDE) protocol, and a private protocol.

The memory interface 240 may interface with the semiconductor memory device 100. For example, the memory interface includes a NAND interface or a NOR interface.

The error correction block 250 may use an error correcting code (ECC) to detect and correct an error in data received from the semiconductor memory device 100. The processor 220 may control a read voltage according to an error detection result of the error correction block 250 and control the semiconductor memory device 100 to perform re-read. According to an embodiment, the error correction block 1150 may be provided as one of the components of the memory controller 200.

The memory controller 200 and the semiconductor memory device 100 may be integrated into a single semiconductor device. In an embodiment, the memory controller 200 and the semiconductor memory device 100 may be integrated into one semiconductor device to constitute a memory card such as a personal computer memory card international association (PCMCIA), a compact flash card (CF), a smart media card (SM or SMC), a memory stick multimedia card (MMC, RS-MMC, or MMCmicro), an SD card (SD, miniSD, microSD, or SDHC), a universal flash storage (UFS), and/or the like.

The memory controller 200 and the semiconductor memory device 100 may be integrated into a single semiconductor device to form a solid state drive (SSD). The solid state drive SSD may include a storage device configured to store data in a semiconductor memory. When the storage device 1000 including the memory controller 200 and the semiconductor memory device 100 serves as a solid state drive (SSD), an operational speed of the host coupled to the storage device 1000 may be significantly improved.

In another example, the storage device 1000 including the memory controller 200 and the semiconductor memory device 100 may be provided as one of various elements of an electronic device such as a computer, a ultra-mobile PC (UMPC), a workstation, a net-book, a personal digital assistants (PDA), a portable computer, a web tablet, a wireless phone, a mobile phone, a smart phone, an e-book, a portable multimedia player (PMP), a game console, a navigation device, a black box, a digital camera, a 3-dimensional television, a digital audio recorder, a digital audio player, a digital picture player, a digital picture recorder, a digital video recorder, a device capable of transmitting/receiving information in an wireless environment, one of various devices for forming a home network, one of various electronic devices for forming a computer network, one of various electronic devices for forming a telematics network, an RFID device, or one of various elements for forming a computing system, or the like.

In an embodiment, the semiconductor memory device 100 or the storage device 1000 including the same may be embedded in any of various types of packages. For example, the semiconductor memory device 100 or the storage device 1000 may be embedded in a package on package (PoP), ball grid arrays (BGAs), chip scale packages (CSPs), a plastic leaded chip carrier (PLCC), a plastic dual in line package (PDIP), a die in waffle pack, a die in wafer form, a chip on board (COB), a ceramic dual in line package (CERDIP), a plastic metric quad flat pack (MQFP), a thin quad flatpack (TQFP), a small outline (SOIC), a shrink small outline package (SSOP), a thin small outline (TSOP), a thin quad flatpack (TQFP), a system in package (SIP), a multichip package (MCP), a wafer-level fabricated package (WFP), a wafer-level processed stack package (WSP), or the like.

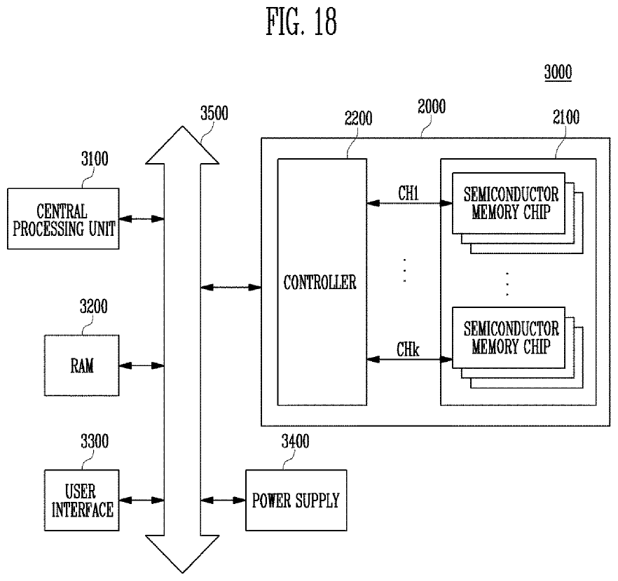

FIG. 17 is a block diagram illustrating an application example of the storage device 1000 of FIG. 1.

Referring to FIG. 17, a storage device 2000 may include a semiconductor memory device 2100 and a controller 2200. The semiconductor memory device 2100 may include a plurality of semiconductor memory chips, which may be divided into a plurality of groups.

In FIG. 17, it is illustrated that first to kth groups communicate with the controller 2200 through first to kth channels CH1 to CHk, respectively. Each of the semiconductor memory chips may be configured and operated in the same manner as the semiconductor memory device 100 described above with reference to FIG. 2.

Each group may be configured to communicate with the controller 2200 through a single common channel. The controller 2200 may be configured in substantially the same manner as the memory controller 200 described with reference to FIG. 17, and configured to control the plurality of memory chips of the semiconductor memory device 2100 through the plurality of first to kth channels CH1 to CHk.

FIG. 18 is a block diagram illustrating a computing system 3000 including the storage device 2000 described with reference to FIG. 17.

The computing system 3000 may include a central processing unit (CPU) 3100, a Random Access Memory (RAM) 3200, a user interface 3300, a power supply 3400, a system bus 3500, and the storage device 2000.

The storage device 2000 may be electrically connected to the CPU 3100, the RAM 3200, the user interface 3300, and the power supply 3400 through the system bus 3500. Data supplied through user interface 3300 or data processed by the CPU 3100 are stored in the storage device 2000.

FIG. 18 illustrates that the semiconductor memory device 2100 is coupled to the system bus 3500 through the controller 2200. However, the semiconductor memory device 2100 may be directly coupled to the system bus 3500. The functions of the controller 2200 may be performed by the CPU 3100 and the RAM 3200.

In FIG. 18, it is illustrated that the storage device 2000 described with reference to FIG. 17 is provided. However, the storage device 2000 may be replaced by the storage device 1000 including the memory controller 200 and the semiconductor memory device 100 as described above with reference to FIG. 16.

According to an embodiment of the disclosure, a memory controller capable of extending the operating life of a semiconductor memory device is provided.

According to another embodiment of the disclosure, a method of operating a memory controller capable of extending an operating life of a semiconductor memory device is provided.

Various embodiments disclosed in the present specification and the drawings aim to help those skilled in this art more clearly understand the present disclosure rather than aiming to limit the bounds of the present disclosure. In other words, those skilled in the art to which the present disclosure pertains will be able to easily understand that various modifications are possible based on the technical scope of the present disclosure. It will be apparent to those skilled in the art that various modifications can be made to any of the above-described embodiments of the present disclosure without departing from the spirit or scope of the disclosure. Thus, the present disclosure covers all such modifications provided they come within the scope of the appended claims and their equivalents.

What is claimed is:

1. A memory controller controlling operations of a memory device, the memory controller comprising:
a group read count storage configured to divide logical block addresses corresponding to data stored in the memory device into a plurality of logical block address groups and store respective read count values of the data corresponding to the logical block addresses according to the logical block address groups; and
a data distribution controller configured to control the memory device to distribute and store data corresponding to a target logical block address group, selected among the plurality of logical block address groups, in a plurality of memory blocks based on the read count values stored according to the logical block address groups.

2. The memory controller of claim 1, wherein the data distribution controller comprises:
a critical count storage configured to store a critical count value;
a count value comparator configured to compare the critical count value with a read count value of the target logical block address group received from the group read count storage; and
a control command generator configured to generate a data distribution command for controlling the memory device to move the data corresponding to the target logical block address group based on a result of comparison by the count value comparator.

3. The memory controller of claim 2, wherein when a read request is received from the host, the group read count storage determines a logical block address group including a logical block address corresponding to the read request as the target logical block address group, and updates the read count value of the target logical block address group.

4. The memory controller of claim 3, wherein the count value comparator compares an updated read count value with the critical count value.

5. The memory controller of claim 4, wherein the control command generator generates the data distribution command when the updated read count value is greater than or equal to the critical count value.

6. The memory controller of claim 5, wherein the group read count storage initializes the read count value of the target logical block address group.

7. The memory controller of claim 1, wherein the data distribution controller comprises:
a timer generating time information;
a target group determiner configured to determine whether a read count check period has elapsed based on the time information and determining the target logical block address group based on the read count values received from the group read count storage when it is determined that the read count check period has elapsed; and
a control command generator configured to generate a data distribution command for controlling the memory device to move the data corresponding to the target logical block address group determined by the target group determiner.

8. The memory controller of claim 7, wherein the target group determiner checks an elapse of time between a previous read count check time and a current time based on the time information and determines whether the read count check period has elapsed based on the check result.

9. The memory controller of claim 8, wherein when it is determined that the read count check period has elapsed, the target group determiner determines a logical block address group corresponding to a largest read count value, among the read count values received from the group read count storage, as the target logical block group address.

10. The memory controller of claim 9, wherein the group read count storage initializes the read count value of the target logical block address group.

11. A method of operating a memory device, the method comprising:
controlling the memory device to perform a read operation according to a read request received from a host;
updating a read count value of a logical block address group including a logical block address corresponding to the read request; and
controlling the memory device to perform a data distribution operation based on the updated read count value.

12. The method of claim 11, wherein the controlling of the memory device to perform the data distribution operation comprises:
determining the logical block address group having the updated read count value as a target logical block address group;
comparing the updated read count value with a critical count value; and
performing a distribution operation on data corresponding to the target logical block address group based on a comparison result.

13. The method of claim 12, wherein the performing of the distribution operation on the data comprises:
determining at least one destination memory block in which the data corresponding to the target logical block address group will be stored;
moving the data corresponding to the target logical block address group to at least one destination memory block; and
initializing a read count value of the target logical block address group.

14. The method of claim 11, wherein the controlling of the memory device to perform the data distribution operation comprises:
determining whether a read count check value has elapsed;
determining a logical block address group having a largest read count value, among a plurality of logical block address groups, as a target logical block address group when it is determined that the read count check period has elapsed; and
performing a data distribution operation on data corresponding to the target logical block address group.

15. The method of claim 14, wherein the performing of the distribution operation on the data comprises:
determining at least one destination memory block in which the data corresponding to the target logical block address group will be stored;
moving the data corresponding to the target logical block address group to at least one destination memory block; and
initializing a read count value of the target logical block address group.

16. The memory controller of claim 1, wherein the memory device comprises a semiconductor memory device.

17. A memory system comprising:
a memory device having memory blocks configured to store data; and
a controller configured to control operations of the memory device, the memory controller further configured to:
store logical block address groups, each containing a plurality of logical block addresses corresponding to data stored in the memory device, in association with respective read count values of the data corresponding to the logical block addresses of the respective logical block address groups,
update the read count values upon receiving a read request or periodically,
identify a target logical block address group, among the logical block address groups, having a read count value satisfying a specific condition, and
move data corresponding to the target logical block address group stored in one or more source memory blocks, among the memory blocks, to one or more destination memory blocks, among the memory blocks, when the read count value of the target logical block address group satisfies the specific condition.
